(19) United States
(12) Patent Application Publication
(10) Pub. No.: US 2004/0168089 A1
(43) Pub. Date: Aug. 26, 2004

(54) Security method for operator access control of network management system

(76) Inventor: Hyun-Sook Lee, Yoingin-city (KR)

Correspondence Address: Robert E. Bushnell, Suite 300, 1522 K Street, N.W., Washington, DC, 20005, US

(21) Appl. No.: 10/777,602

(22) Filed: Feb. 13, 2004

(30) Foreign Application Priority Data
Feb. 19, 2003 (KR) 10-2003-10509
May 29, 2003 (KR) 10-2003-34534

(51) Int. Cl. G06F 11/30

(52) U.S. Cl. 713/201

(57) ABSTRACT

To access control without changing a presently used version of a system application protocol, an operator enters an ID and a password of the operator for user authentication, and, if the user authentication is successful, the operator will have access to an application layer of a system managed using either TCP/IP or UDP/IP. The application layer is adapted to be accessed using a security module to confirm whether or not an IP address of a terminal used by the operator is a preset IP address. In a network operating a version of a network management interface not equipped with a security function, the security deficiency of the system is alleviated by simply adding the security module without effecting a version upgrade process.

### CLAIM OF PRIORITY

This application makes reference to, incorporates the same herein, and claims all benefits accruing under 35 U.S.C. §119 from an application for SECURITY METHOD FOR OPERATOR ACCESS CONTROL OF NETWORK MANAGEMENT SYSTEM earlier filed in the Korean Intellectual Property Office on 19 Feb. 2003 and 29 May 2003, there duly assigned Serial Nos. 2003-10509 & 2003-34534, respectively.

### BACKGROUND OF THE INVENTION

1. Technical Field

The present invention relates to a security method for operator access control of a network management system, which enables effecting access control without changing a version of a system application protocol.

2. Related Art

Currently, most network devices associated with networks including the Internet use a network management protocol based on a Simple Network Management Protocol (SNMP) to manage the networks and monitor operations of the network devices. The SNMP is the most general network management protocol, and has been updated into versions, SNMPv1, SNMPv2 and SNMPv3 with greatly improved functions. Most of the network systems are adapted to serve an Element Management System (EMS) based on a Graphic User Interface (GUI) that uses such an SNMP, and a Command Line Interface (CLI) that directly receives and processes a command via an external terminal.

As the SNMP used in the network management system configured as above, SNMPv1, SNMPv2 and SNMPv3 have been introduced in this order. Both SNMPv1 and SNMPv2, mainly use an access restriction method of checking “read-only”/“read-write” communities, while in case of SNMPv3, a security module is present in the protocol.

The community implies a specification of a password system, which is defined between a manager and an agent.

For example, a typical community in each of the SNMPv1 and SNMPv2 is used as a “public” community in case of a “read-only” and a “private” community in case of “read-write”. Moreover, these communities in certain systems are hard coded, which makes it difficult to modify the communities. A security problem with such systems could arise when unauthorized users can access the network management system due to the exposure of a community password.

### SUMMARY OF THE INVENTION

Therefore, the present invention has been made in view of the above problems, and it is an object of the present invention to provide a method for effecting access control without changing a currently used version of a system application protocol.

According to the present invention, there is provided a security method for operator access control of a network management system, the method comprising performing an IP (Internet Protocol) filtering to enable an external operator to determine whether or not an IP address of the operator is a preset IP address using one of a TCP/IP (Transmission Control Protocol/Internet protocol) or a UDP/IP (User Datagram Protocol/Internet protocol); and connecting the external operator to a communication system by inputting an ID/password or by setting communities upon a determination that the IP address of the operator is a preset IP address.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a block diagram of a network management system using a simple network management protocol (SNMP) and CLI (TL1) that is applied to the present invention;

FIG. 2 is a diagram explaining a network management system in connection with a disadvantageous OSI reference model;

FIG. 3 is a diagram explaining a network management system in connection with an OSI reference model according to according to an embodiment of the present invention;

FIG. 4 is a diagram illustrating an instance of a filtering table organized using an MIB defined according to an embodiment of the present invention; and

FIG. 5 is a flowchart of a security process for an operator access restriction in a network management system according to an embodiment of the present invention.

### DETAILED DESCRIPTION

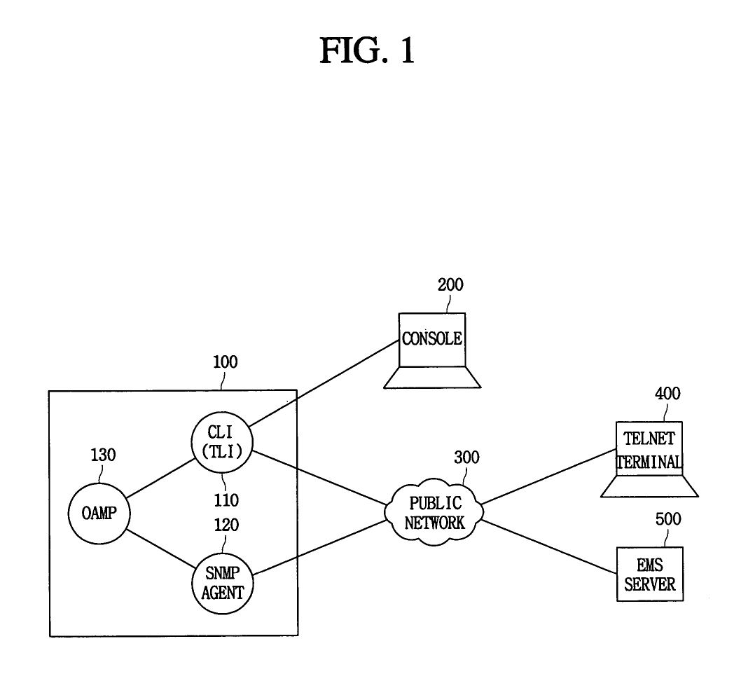

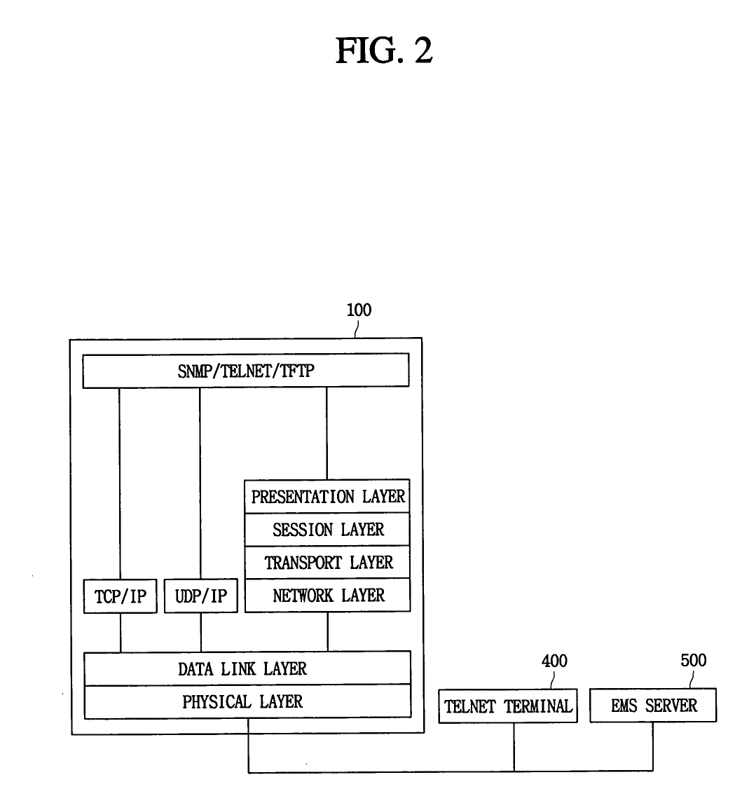

FIG. 1 is a block diagram of a network management system using a simple network management protocol (SNMP) and CLI (TL1) that is applied to an embodiment of the present invention, and FIG. 2 is a diagram explaining a network management system in connection with a disadvantageous OSI reference model.

Referring to FIG. 1, a network management interface provided by a system 100 includes a “TL1/CLI (Transaction Language 1/Command Line Interface) 110” and an “SNMP agent 120”. The system will manage a configuration, an alert, a performance, etc. of the system via such management channels.

In case of the TL1 110, the TL1 may manage the system 100 through direct connection to external consoles 200 by means of serial ports, and may also remotely manage the system with a telnet 400 over a public network 300.

Meanwhile, the SNMP agent 120 is connected to and uses an EMS (Element Management System) server 500 over the public network 300 using UDP (User Datagram Protocol)/IP. Alternatively, an OSI (Open Systems Interconnection) CLNP (Connectionless Network Protocol) may be used.

The TL1 110 and the SNMP agent 120 fetch or modify desired data from OAMP (Operations Administration Maintenance Provisioning) 130 over IPC (InterProcess Communication), respectively.

Referring to FIG. 2, a telnet terminal 400 or an EMS server 500 is connected to a data link layer via a physical layer so as to have access to an application layer (SNMP/telnet/TFTP: Trivial File Transfer Protocol) in a TCP/IP manner or in an UDP/IP manner.

An embodiment of the present invention is described herein below with reference to the accompanying drawings. In the following description, well-known functions or constructions are not described in detail since they would obscure the invention with unnecessary detail.

A configuration of a network management system using a simple network management protocols (i.e., SNMP) and CLI (i.e., TL1), which are applied to the present invention, is the same as that discussed above. Therefore, a further explanation of the configuration has been omitted for the sake of brevity.

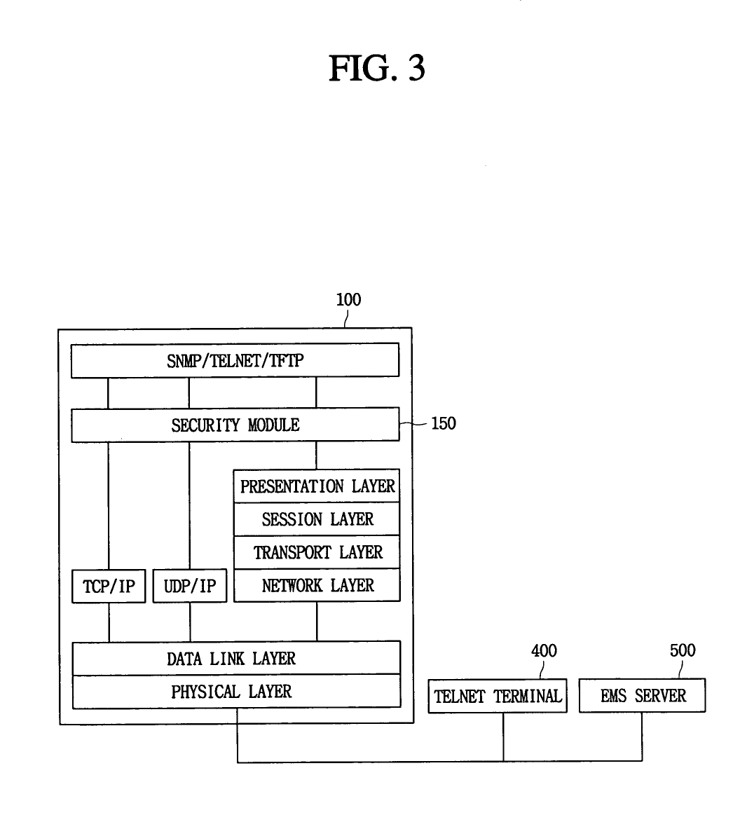

FIG. 3 is a diagram explaining a network management system in connection with an OSI reference model according to an embodiment of the present invention

Referring to FIGS. 1 and 3, in case of performing a network management operation using a TL1 110, an operator first enters an ID and a password of the operator for user authentication. If the user authentication is successful, the operator will have access to an application layer of a system to be managed via TCP/IP or UDP/IP. At this time, the network management system is adapted to have access to the application layer via a security module to confirm whether an IP address of a terminal that the operator is using is a preset IP address.

That is, a telnet terminal (400) which is a remote management channel via the IP network (for example, the public network in FIG. 1) has a filtering function in which the IP address of an operation terminal, which uses a telnet protocol in addition to an ID/password security device, can serve as a security key.

Here, this module is implemented by a very separate task from a “CLI (Command Line Interface)” task by which a “TL1” function is implemented.

Elementary security in the SNMPv1 and SNMPv2 is realized by the community, and the community includes a “read-only” community and a “read-write” community, to which it may be unusual to permit any modification.

In this embodiment of the present invention, for the sake of the security of these communities, modification of each of the communities is allowed only by a “TL1” command. In other words, it is impossible to read or modify the communities using the “SNMP”, and it is therefore necessary for the operator to know the “TL1” command in order to communicate with the EMS server 500. When the community is to be modified, it is also necessary to compromise with the managing EMS server 500.

Moreover, when the SNMPv1 and SNMPv2 use UDP/IP or TCP/IP, as in the “TL1”, security is effected via the IP filtering using the IP address of the operator as a key, which is represented by the MIB in Tables 1 to 17.

Table 1 indicates the policy ID of a system for filtering ingress packets. A value of this object is that of an “entFilterPolicyId” in an “entFilterPolicyTable.”

Also, ‘DEFVAL’ accepts all ingress packets.

TABLE 1

entIngressFilterPolicyId OBJECT-TYPE

SYNTAX INTEGER (0..255)
MAX-ACCESS read-write
STATUS current
DESCRIPTION

″

Indicates the policy id of system
for filtering ingress packets.
The value of this object is that of
entFilterPolicyId
inentFilterPolicyTable.
‘DEFVAL’ : accept all ingress packets

″

DEFVAL { 0 }
::= {entConfig 13}

Moreover, Table 2 indicates the policy ID of a system for filtering egress packets. The value of this object is that of the “entFilterPolicyld” in the “entFilterPolicyTable”. Also, the ‘DEFVAL’ does not discard all egress packets.

TABLE 2

entEgressFilterPolicyId OBJECT-TYPE

SYNTAX INTEGER (0..255)
MAX-ACCESS read-write
STATUS current
DESCRIPTION

″

Indicates the policy id of system for
filtering ingress packets.
The value of this object is that of
entFilterPolicyId
inentFilterPolicyTable.
‘DEFVAL’ : not discard all egress packets

″

DEFVAL { 0 }
::= {entConfig 14}

Table 3 contains the filtering policy of the system on ingress/egress packets. A row in this table is pointing a row in a protocol table such as an “entFilterIpTable.”

For creating a row in this table, the row that is pointed by an “entFilterPolicyPointer” object is first created.

Further, for destroying a row in this table, the row that is pointed by the “entFilterPolicyPointer” object is first destroyed.

TABLE 3

entFilterPolicyTable OBJECT-TYPE

SYNTAX SEQUENCE OF EntFilterPolicyEntry
MAX-ACCESS not-accessible
STATUS current
DESCRIPTION
″

This table contains the filtering policies of system
on ingress/egress packet.
A row in this table is pointing a row in
protocol table
such as entFilterIpTable.
For creating a row in this table, the row
that is pointed
by entFilterPolicyPointer object was first created.
And for destroying a row in this table, the
row that is pointed
by entFilterPolicyPointer object was first destroyed.

″

::= {entConfig 15 }

Further, in Table 4, each entry consists of a list of parameters that represent a filtering policy on the system.

TABLE 4

entFilterPolicyEntry OBJECT-TYPE

SYNTAX EntFilterPolicyEntry
MAX-ACCESS not-accessible
STATUS current
DESCRIPTION
″

Each entry consists of a list of parameters that
represents filtering policy on a system.

| ″ | |
|---|---|
| INDEX | { entFilterPolicyIndex } |

::= { entFilterPolicyTable 1 }

Table 5 denotes an index into the “entFilterPolicyTable”.

TABLE 5

entFilterPolicyIndex OBJECT-TYPE

SYNTAX INTEGER(1..9)
MAX-ACCESS read-only
STATUS current
DESCRIPTION

″

The index into the entFilterPolicyTable.

″

::= {entFilterPolicyEntry 1 }

Further, Table 6 indicates the identification of the ingress or egress policy. The same policy ID could belong to many rows in this table.

TABLE 6

entFilterPolicyId OBJECT-TYPE

SYNTAX INTEGER(1..255)
MAX-ACCESS read-create
STATUS current
DESCRIPTION

″

Indicates the identification of ingress
or egress policy.
A same policy id could belong to many rows
in this table.

″

::= { entFilterPolicyEntry 2 }

Table 7 represents to a pointer to a row in a protocol table such as the “entFilterIpTable”. The value is the name of the instance of the first columnar object in the protocol table.

For example, “entFilterIpIndex.3” that is the value of the instance of this object would point to the third row in the “entfilterip” table.

TABLE 7

entFilterPolicyPointer OBJECT-TYPE

SYNTAX RowPointer
MAX-ACCESS read-create
STATUS current
DESCRIPTION

″

Represents a pointer to a row in protocol
table such as

entFilterIp table. The value is the name of the instance
of the first columnar object in the
protocol table.

```
For example, entFilterIpIndex.3 that is the
value of the instance of
  this object would point to the 3rd row
  in the entFilterIp table.
```

″

::= {entFilterPolicyEntry 3 }

Furthermore, an object in Table 8 is used to create a new row, or modify or delete an existing row in this table.

If the related row of a protocol table such as the “entFilterIp” table wasn't created, a row in this table would not be created.

TABLE 8

entFilterPolicyRowStatus OBJECT-TYPE

SYNTAX RowStatus
MAX-ACCESS read-create
STATUS current
DESCRIPTION

″

This object is used to create a new row
or modify or
delete an existing row in this table.
If the related row of protocol table such
as entFilterIp table wasn't

created, a row in this table could have not been created.

The related row of protocol table should
have been first

Destroyed before a row in this table is destroyed.

″

::= { entFilterPolicyEntry 4 }

Table 9 contains details of a filter policy over the IP protocol.

TABLE 9

entFilterIpTable OBJECT-TYPE

SYNTAX SEQUENCE OF EntFilterIpEntry
MAX-ACCESS not-accessible
STATUS current
DESCRIPTION
″

This table contains the details of a filter policy

over IP protocol.

″
::= { entConfig 16 }

Each entry in Table 10 consists of a list of parameters that represents a filter policy over the IP protocol.

TABLE 10

entFilterIpEntry OBJECT-TYPE

SYNTAX EntFilterIpEntry
MAX-ACCESS not-accessible
STATUS current
DESCRIPTION
″

Each entry consists of a list of parameters that
represents a filter policy over IP protocol.

″
INDEX { entFilterIpIndex }
::= { entFilterIpTable 1 }

entFilterIpEntry ::= SEQUENCE {

| | |
|---|---|
| entFilterIpIndex | INTEGER, |
| entFilterIp | IpAddress, |
| entFilterIpMask | IpAddress, |
| entFilterIpPortNum | INTEGER, |
| entFilterIpProtocol | INTEGER, |
| entFilterIpControl | INTEGER, |
| entFilterIpRowStatus | RowStatus |

}

Table 11 indicates the index into the “entFilterIpTable”.

TABLE 11

entFilterIpIndex OBJECT-TYPE

SYNTAX INTEGER(1..9)
MAX-ACCESS read-only
STATUS current
DESCRIPTION

″

The index into the entFilterIpTable.

″

::= { entFilterIpEntry 1 }

Table 12 indicates an IP address applied to the filter policy.

TABLE 12

entFilterIp OBJECT-TYPE

SYNTAX IpAddress
MAX-ACCESS read-create
STATUS current
DESCRIPTION

″

Indicates ip address applied to a filter policy.

″

DEFVAL { ‘00000000’h }
::= { entFilterIpEntry 2 }

Table 13 indicates a mask of the IP address. When the “entFilterIpProtocol” is a telnet, the system always applies ‘DEFVAL’ to the instance of this object.

TABLE 13

entFilterIpMask OBJECT-TYPE

SYNTAX IpAddress
MAX-ACCESS read-create
STATUS current
DESCRIPTION

″

Indicates the mask of ip address.
When entFilterIpProtocol is telnet,
system always applies ‘DEFVAL’
to the instance of this object.

″

DEFVAL { ‘ffffffff’h }
::= { entFilterIpEntry 3 }

Table 14 indicates an applied port number to the filter policy.

TABLE 14

entFilterIpPortNum OBJECT-TYPE

SYNTAX Integer
MAX-ACCESS read-create
STATUS current
DESCRIPTION

″

Indicates the applied port number to a filter policy.

″

::= { entFilterIpEntry 4 }

Table 15 indicates a protocol to be applicable to the filter policy.

TABLE 15

entFilterIpProtocol OBJECT-TYPE

SYNTAX INTEGER { snmp(1), telnet(2),
tftp(3) }
MAX-ACCESS read-create
STATUS current
DESCRIPTION

″

Indicates the applied protocol
over IP protocol to a filter policy.

″

::= { entFilterIpEntry 5 }

In Table 16, it is determined whether to discard or accept the packet.

TABLE 16

entFilterIpControl OBJECT-TYPE

SYNTAX INTEGER { discard(1), accept(2) }
MAX-ACCESS read-create
STATUS current
DESCRIPTION

″

Determines whether to discard or accept a packet.

″

::= { entFilterIpEntry 6 }

This object in Table 17 is used to create a new row, or modify or delete an existing row in this table.

TABLE 17

entFilterIpRowStatus OBJECT-TYPE

SYNTAX RowStatus
MAX-ACCESS read-create
STATUS current
DESCRIPTION

″

This object is used to create
a new row or modify or
delete an existing row in this table.

″

::= { entFilterIpEntry 7 }

The filtering operation will be now described by way of MIB objects represented in Tables 1 to 17. First, a filtering range for the objects in the “entFilterIpTable” is set and thereafter a row is created. At this time, the meaning of the “entFilterIpProtocol” can be defined as “a protocol over an IP”.

Here, protocols to be filtered may be SNMP, Telnet, TFTP (Trivial File Transfer Protocol), etc. In the “entFilterIpControl”, there exists a value that could be set to indicate whether to discard and accept the packet.

When the relevant row is used as an egress policy, a request for an SNMP packet is accepted while a response packet is not sent out. Of course, it is applied to a trap as well, and accordingly a trap packet is also not transferred to the registered EMS server 500. On the other hand, when the relevant row is used as an ingress policy, an inverse operation is performed. Once the row of the “entFilterIpTable” is created, the row of the “entFilterPolicyTable” must be accordingly created. This table is implemented for providing such versatility that several rows are contained in one policy.

In addition, the “entFilterPolicyPointer” is pointing the row of the “entFilterIpTable” organized as above. Here, the “entFilterPolicyld” is implemented into a structure allowed for several “rows” to have the same value. Also, values of the “entIngressFilterPolicyId” and the “entEgressFilterPolicyId” are set. These values affect entire packets communicated between the system and other equipments.

Objects represented by Tables 1 to 17 will be now described as a practical instance.

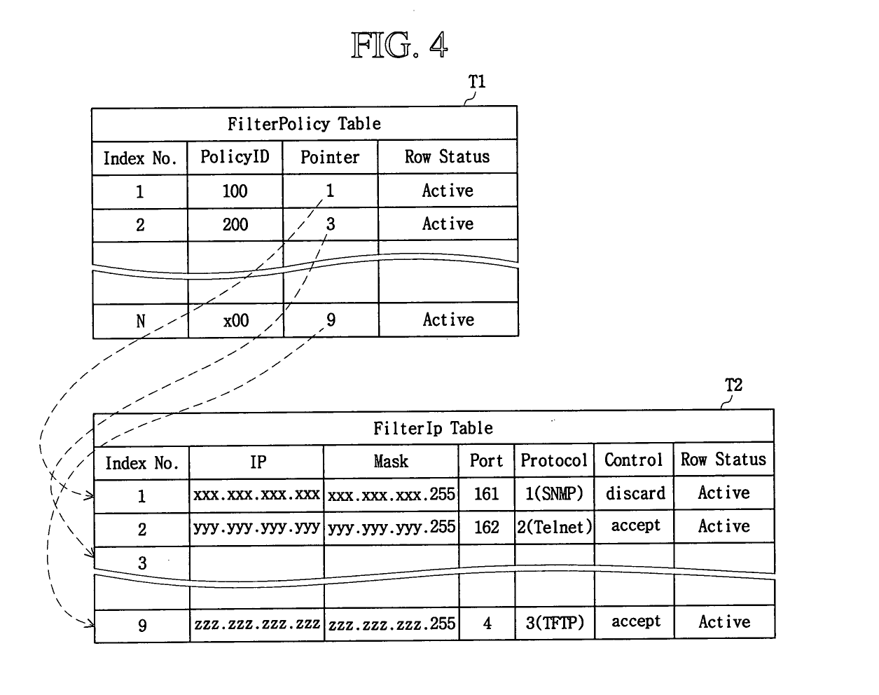

FIG. 4 illustrates an instance of a filtering table composed using the MIB defined in the present invention.

Referring to FIG. 4, the filtering table includes a FilterPolicy table T1 consisting of a field for PolicyID (PID) numbers selected by the operator, a pointer field having pointer values corresponding to respective PolicyIDs, and a row status field indicating status of the relevant “rows”; and a FilterIp table T2 consisting of an index number field taking pointer values of the FilterPolicy table T1 as index numbers, an IP field representing an IP address for each relevant row, a mask field enabling to set a group by masking the IP address, a port number field, a protocol field, a control field, and a row status field.

Each of the PolicyID field, the pointer field and the row status field in the FilterPolicy table T1 is of an integer type. However, each of integers of the PolicyId field and pointer field means a figure itself, while an integer of the row status field has a meaning represented by its figure.

For example, integers of the status field, 1, 2, 3, 4, 5 and 6 are defined to indicate that status of the “rows” are active, notInService, notReady, createAndGo, createAndWait and destroy, respectively.

Meanwhile, in case of the FilterIp table T2, each of the index number filed, the port number field, the protocol field, the control field and the row status field is of an integer type, while each of the IP address field and the IP address mask field is of an IP address type (xxx.xxx.xxx.xxx). However, each of the integers of the protocol field, the control field and the row status field has a meaning represented by each figure.

For example, values “1”, “2” and “3” of the protocol field are defined to indicate that protocol types are SNMP, Telnet and TFTP, respectively.

Moreover, values “1” and “2” of the control field are defined to indicate “discard” and “accept”, respectively.

Also, figures of the row status field are defined in the same manner as the row status field of the FilterPolicy table T1.

Hereinafter, a process will be discussed in which the operator practically performs access permission/denial using the above-described tables.

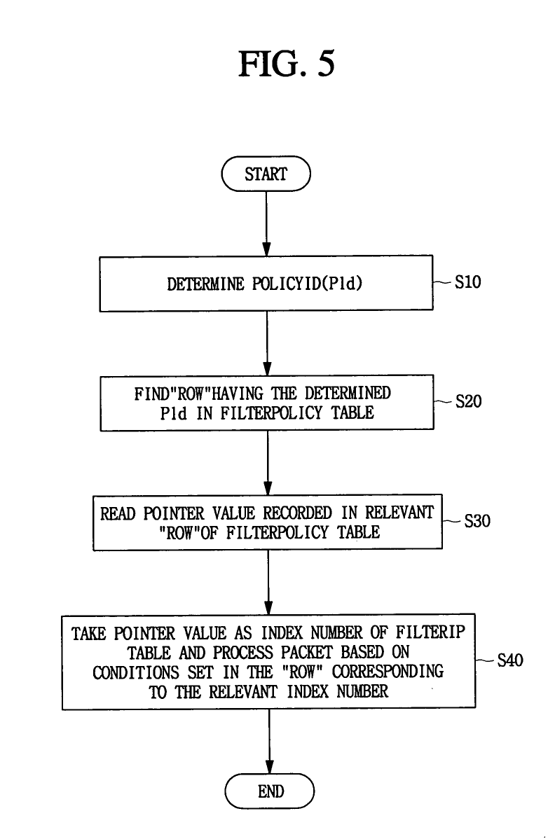

FIG. 5 is a flowchart of a security process for an operator access restriction in a network management system according to an embodiment of the present invention.

Referring to FIG. 5, first, a policy on how to process the packet is determined and a Policy Id (PId) for the determined policy is determined (S 10).

A row, which has a value corresponding to the PId value determined at S10, is found in Table 1 (S20).

A pointer value of the row found at S20 is read (S30), and a relevant row is found in the FilterIp Table T2 taking a pointer value as an index number to process the packet based on conditions set in the relevant row (an IP address, a mask, a port number, a protocol and an IP control method) (S40).

For example, if the PolicyId (PId) is determined to be 100, it indicates the “row' corresponding to the index number 1 of the FilterPolicy table 1. Since the pointer value of the row corresponding to the index number 1 is “1”, conditions corresponding to the row that corresponds to the index number 1 of the FilterIp table 2 will be carried out.

Accordingly, in a situation that the policy Id is determined as 100, if the operator access is attempted from a terminal of an IP address different from the IP address set in the first row of the FilterIP table, it will be failed. Moreover, although the IP addresses are the same, if the packet is transmitted and received to and from a port number different from a preset port number 161, the operator access will be also failed.

Subsequently, there is presented in Table 18 an instance of a result obtained by performing the “TL1” command on community modification and inquiry for the SNMPv1 and SNMPv2.

TABLE 18
SU-WON> rtrv-community;
IP C01240
<

SU-WON 2002-02-02 01:56:40

M C01240 COMPLD
“RD=SamsungAcemap,WR=K_SAMSUNG_Acemap2000_set,TR=SS_Acemap_Trap”

/* RTRV-COMMUNITY;[CO1240]*/

;

Where, “RD”, “WR” and “TR” mean a “read-only” community, a “read-write” community and a “trap” community, respectively. They may be modified and inquired only by the “TL1” command. The communities must be modified even in the EMS server 500 so that the EMS server 500 is managed upon modification.

If each community password is modified as above, it results in a different community password from a normal password. Accordingly, no community password will be easily exposed to others.

Although embodiments of the present invention have been described above, those skilled in the art will appreciate that various modifications and alternatives of the present invention are possible, without departing from the scope and spirit of the invention as defined in the accompanying claims. Accordingly, the technique of the present invention covers other embodiments of the present invention.

According to the present invention as described above, it is possible to simply maintain security upon connection to a network management interface by adding a security module for performing an IP filtering without upgrading SNMPv1 and SNMPv2 into SNMPv3 offering a security function, in a system having a network management protocol of which a version that is the same as that of the EMS is being operated.

What is claimed is:

1. A security method for operator access control of a network management system, the method comprising:
performing an Internet Protocol (IP) filtering to determine whether or not an inputted Internet Protocol address of an external operator is a preset Internet Protocol address using one of either a Transmission Control Protocol/Internet protocol (TCP/IP) or a User Datagram Protocol/Internet protocol (UDP/IP); and
connecting the external operator to a communication system by either inputting an Identifier/Password or by setting communities upon a determination that the Internet Protocol address of the external operator is a preset Internet Protocol address.

2. The security method according to claim 1, wherein performing an Internet Protocol (IP) filtering comprises:
a) creating a row after setting a filtering range for objects that are implemented by a Management Information Base (MIB);
b) selecting whether to discard or accept a Simple Network Management Protocol (SNMP) packet to be inputted or outputted;
c) selectively accepting a request for the Simple Network Management Protocol (SNMP) packet if the row is used as an egress policy, while not outputting a response packet; and
d) selectively outputting the response packet for the Simple Network Management Protocol (SNMP) packet if the row is used as an ingress policy, while not allowing accepting the request for the Simple Network Management Protocol (SNMP) packet.

3. The security method according to claim 2, wherein creating a row after setting a filtering range for objects that are implemented by a Management Information Base (MIB) comprises:
e) determining a PolicyId (PId) as to whether or not to adopt a certain packet processing method;
f) finding a row in a FilterPolicy table, the row having a relevant value based on the determined PolicyId value;
g) reading a pointer value of the row found in the FilterPolicy table; and
h) finding a relevant row in a FilterIp table using the previously read pointer value as an index number, and then determining whether or not operator access is permitted based on conditions for an Internet Protocol (IP) address and a port number set in the relevant row to process a packet.

4. The security method according to claim 3, wherein the FilterIp table, in which items of the conditions for determining whether or not the operator access is permitted are recorded, comprises:
an index number field using a pointer value corresponding to the policyId as an index, an Internet Protocol (IP) address field, an Internet Protocol (IP) address mask field, a port number field, a protocol field, a control field, and a row status field.

5. The security method according to claim 4, wherein a syntax of each of the index number field, the port number field, the protocol field, the control field and the row status field is of an integer type, and
a syntax of each of the Internet Protocol (IP) address field and the Internet Protocol (IP) address mask field is of an Internet Protocol (IP) address type.

6. The security method according to claim 1, where the external operator comprises one of a telnet terminal or an Element Management System (EMS) server.

7. A program storage device, readable by machine, tangibly embodying a program of instructions executable by the machine to perform a security method for operator access control of a network management system, the method comprising:
performing an Internet Protocol (IP) filtering to determine whether or not an inputted Internet Protocol address of an external operator is a preset Internet Protocol address using one of either a Transmission Control Protocol/Internet protocol (TCP/IP) or a User Datagram Protocol/Internet protocol (UDP/IP); and
connecting the external operator to a communication system by either inputting an Identifier/Password or by setting communities upon a determination that the Internet Protocol address of the external operator is a preset Internet Protocol address.

8. The program storage device according to claim 7, wherein performing an Internet Protocol (IP) filtering comprises:
a) creating a row after setting a filtering range for objects that are implemented by a Management Information Base (MIB);
b) selecting whether to discard or accept a Simple Network Management Protocol (SNMP) packet to be inputted or outputted;
c) selectively accepting a request for the Simple Network Management Protocol (SNMP) packet if the row is used as an egress policy, while not outputting a response packet; and
d) selectively outputting the response packet for the Simple Network Management Protocol (SNMP) packet if the row is used as an ingress policy, while not allowing accepting the request for the Simple Network Management Protocol (SNMP) packet.

9. The program storage device according to claim 8, wherein creating a row after setting a filtering range for objects that are implemented by a Management Information Base (MIB) comprises:
e) determining a PolicyId (PId) as to whether or not to adopt a certain packet processing method;
f) finding a row in a FilterPolicy table, the row having a relevant value based on the determined PolicyId value;
g) reading a pointer value of the row found in the FilterPolicy table; and
h) finding a relevant row in a FilterIp table using the previously read pointer value as an index number, and then determining whether or not operator access is permitted based on conditions for an Internet Protocol (IP) address and a port number set in the relevant row to process a packet.

10. The program storage device according to claim 9, wherein the FilterIp table, in which items of the conditions for determining whether or not the operator access is permitted are recorded, comprises:
an index number field using a pointer value corresponding to the policyId as an index, an Internet Protocol (IP) address field, an Internet Protocol (IP) address mask field, a port number field, a protocol field, a control field, and a row status field.

11. The program storage device according to claim 10, wherein a syntax of each of the index number field, the port number field, the protocol field, the control field and the row status field is of an integer type, and a syntax of each of the Internet Protocol (IP) address field and the Internet Protocol (IP) address mask field is of an Internet Protocol (IP) address type.

12. The program storage device according to claim 7, where the external operator comprises one of a telnet terminal or an Element Management System (EMS) server.
